(19) United States
(12) Patent Application Publication
(10) Pub. No.: US 2014/0204493 A1
(43) Pub. Date: Jul. 24, 2014

(54) Relay Control Circuit

(71) Applicant: General Electric Company, Schenectady, NY (US)

(72) Inventors: Murali Krishna Bezawada, Andhra Pradesh (IN); Manoj Kumar Vadali, Andhra Pradesh (IN)

(73) Assignee: General Electric Company, Schenectady, NY (US)

(21) Appl. No.: 14/219,788

(22) Filed: Mar. 19, 2014

Related U.S. Application Data
(63) Continuation of application No. 13/162,787, filed on Jun. 17, 2011, now abandoned.

(51) Int. Cl. H01H 47/36; H02H 9/02

(52) U.S. Cl. CPC H01H 47/36; H02H 9/02
USPC 361/93.9

(57) ABSTRACT

A relay control circuit is disclosed. In one aspect, the relay control circuit is a hybrid of a double winding relay control scheme and a single winding relay control scheme.

### CROSS-REFERENCE TO RELATED APPLICATIONS

This application is a continuation of currently pending U.S. patent application Ser. No. 13/162,787, filed on Jun. 17, 2011. U.S. patent application Ser. No. 13/162,787 is incorporated herein by reference in its entirety for all that it contains in order to provide continuity of disclosure.

### BACKGROUND OF THE INVENTION

The present invention relates generally to meters, and more particularly to a relay control circuit for controlling operation of relays used by an electric meter.

Electric meters are typically implemented with various relays that perform different functions. For example, an electric meter may utilize a disconnect relay that can remove electrical service from a customer that is attached to the meter. Having the disconnect relay under the cover of an electric meter along with a two-way communication device enables remote activation and deactivation of the relay, so that the electric service can be reconnected and disconnected. Other relays that may be utilized by an electric meter include ancillary relays that control specific loads (e.g., a heater load, circuit breaker, etc.). All of the relays used by an electric meter are generally controlled by a relay control circuit. There are various types of relay control circuits that can be utilized by an electric meter having multiple relays. A relay control circuit utilizing a single winding relay control scheme and a relay control circuit utilizing a double winding relay control scheme are examples of some control circuits that have been used with electric meters to control multiple relays. However, these relay control circuits and their respective control schemes (i.e., a single winding relay control scheme and a double winding relay control scheme) have their respective drawbacks with respect to energy usage (i.e., the energy necessary to operate the elements (e.g., switches and winding coils) associated with a particular scheme) and the amount of these elements used in each scheme.

### BRIEF DESCRIPTION OF THE INVENTION

In one aspect of the present invention, a circuit is provided. The circuit comprises more than one relay coil each connected to a corresponding relay; a pair of common control switches connected to each of the relay coils; and a plurality of relay coil specific switch pairs, each relay coil specific switch pair connected to one of the relay coils, wherein each relay coil specific switch pair is connected to one of the relay coils at an end opposite a connection of the pair of common control switches with each of the relay coils; wherein the pair of common control switches and the plurality of relay coil specific switch pairs operate cooperatively to selectively open and close the relay coils which selectively open and close a corresponding relay.

In another aspect of the present invention, a circuit is provided. In this aspect of the present invention, the circuit comprises more than one relay coil each connected to a corresponding relay; a pair of common control switches connected to each of the relay coils, wherein the pair of common control switches connect to each of the relay coils at a common end; a plurality of relay coil specific switch pairs, each relay coil specific switch pair connected to one of the relay coils, wherein each relay coil specific switch pair is connected to one of the relay coils at an end opposite a connection of the pair of common control switches with each of the relay coils; and a current limiting mechanism connected to the plurality of relay coil specific switch pairs and the pair of common control switches.

In a third aspect of the present invention, a utility meter is provided. In this aspect of the present invention, the utility meter comprises more than one relay; a relay control circuit configured to selectively open and close each of the relays, the relay control circuit comprising more than one relay coil each connected to a corresponding relay, a pair of common control switches connected to each of the relay coils, wherein the pair of common control switches connects to each of the relay coils at a common end; and a plurality of relay coil specific switch pairs, each relay coil specific switch pair connected to one of the relay coils, wherein each relay coil specific switch pair is connected to one of the relay coils at an end opposite a connection of the pair of common control switches with each of the relay coils; and a microcontroller, operatively coupled to the relay control circuit, that is configured to direct the relay control circuit to selectively open and close the relays.

### BRIEF DESCRIPTION OF THE DRAWINGS

FIG. 1 is a schematic diagram illustrating an electric meter according to one embodiment of the present invention;

FIG. 2 is a schematic circuit diagram of a relay control circuit that may be implemented in the electric meter depicted in FIG. 1 according to one embodiment of the present invention;

FIG. 3 is a schematic circuit diagram of a relay control circuit that may be implemented in the electric meter depicted in FIG. 1 according to a first alternative embodiment;

FIG. 4 is a schematic circuit diagram of a relay control circuit that may be implemented in the electric meter depicted in FIG. 1 according to a second alternative embodiment;

FIG. 5 is a schematic circuit diagram of a relay control circuit that may be implemented in the electric meter depicted in FIG. 1 according to a third alternative embodiment;

FIG. 6 is a circuit implementation of the diagram illustrated in FIG. 3 according to one embodiment of the present invention; and

FIG. 7 is a circuit implementation of the diagram illustrated in FIG. 5 according to one embodiment of the present invention.

### DETAILED DESCRIPTION OF THE INVENTION

Various embodiments of the present invention are directed to a relay control circuit used with a utility meter such as an electric meter. In one embodiment, the relay control circuit is a hybrid of a single winding relay control scheme and a double winding relay control scheme. In one embodiment, the relay control circuit comprises more than one relay coil each connected to a corresponding relay, a pair of common control switches connected to one end of each of the relay coils, and a plurality of relay coil specific pair switches. Each relay coil specific switch pair is connected to the other end of the relay coils. The pair of common control switches and the plurality of relay coil specific switch pairs operate cooperatively to selectively open and close the relay coils, which selectively open and close a corresponding relay. In one embodiment, the relay control circuit can have a current limiting mechanism connected to the plurality of relay coil specific pair switches and common control switches to avoid shoot through and protect the switches from permanent damage. In one embodiment, the current limiting mechanism may include a resistor network. In another embodiment, the current limiting mechanism may include a short circuit protection logic circuit.

Technical effects of the various embodiments of the present invention include an improved relay control circuit that has low costs associated with the energy necessary to operate its elements in the circuit and low costs in the amount of these elements used in the circuit. Additional technical effects include a relay control circuit that performs with high reliability and immunity to noise. Other technical effects include a relay control circuit that avoids unintentional “CLOSE” operations of a main disconnect relay, and thus obviating safety issues to utility customers.

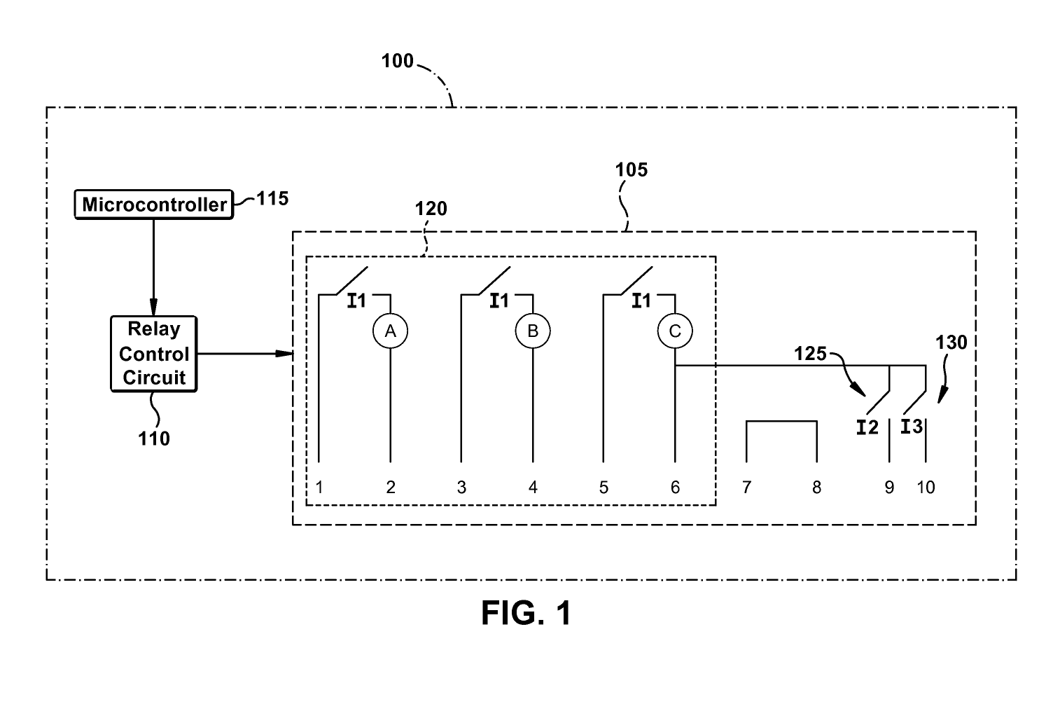

FIG. 1 is a schematic diagram illustrating an electric meter 100 according to one embodiment of the present invention. Although various embodiments of the present invention are described with respect to use with an electric meter and an electric utility service, the embodiments are not limited to use solely with these items. Those skilled in the art will recognize that the various embodiments of the present invention are suitable for use with other metering devices and utility services. A non-exhaustive list of other metering devices where the various embodiments of the present invention are suitable for use include gas, water and heat meters. Similarly, a non-exhaustive list of other utility services where the various embodiments of the present invention are suitable for use include gas, water and heat services.

As shown in FIG. 1, electric meter 100 includes a set of relays 105 controlled by a relay control circuit 110 and a microcontroller 115. In one embodiment the set of relays 105 comprises three relays—a service disconnect relay 120, a first ancillary relay 125 and a second ancillary relay 130. Service disconnect relay 120 enables reconnecting and disconnecting of the electrical service, while first ancillary relay 125 and second ancillary relay 130 are for controlling ancillary single phase loads (e.g., a heated load, circuit breaker, etc.). In one embodiment, service disconnect relay 120 includes three relays represented as I1. Each I1 relay is used for connecting/disconnecting one of three phases (i.e., Phase A, Phase B and Phase C). Although not shown in FIG. 1, the three I1 relays of service disconnect relay 120 are mechanically connected to form a single relay. For each of the three I1 relays of service disconnect relay 120, there is a line that connects to the electric service (i.e., lines 1, 3 and 5) and a line that connects to a load (i.e., lines 2, 4 and 6). In one embodiment, first ancillary relay 125 is represented as I2 that connects to an ancillary load via line 9 and second ancillary relay 130 represented as 13 that connects to an ancillary load via line 10. FIG. 1 further shows that the set of relays 105 has two neutral lines (e.g., lines 7 and 8); line 7 connects to the electric service and line 8 connects to the load. Operation of service disconnect relay 120, first ancillary relay 125 and second ancillary relay 130 is dictated by microcontroller 115. In particular, microcontroller generates control signals representative of a certain operational action for the relays that are put into effect by relay control circuit 110. Those skilled in the art will recognize that the I1, I2 and I3 relays can be rated to have differing current values depending on the particular application of each relay. In addition, those skilled in the art will recognize that the I1, I2 and I3 relays can be all single phase or all polyphase or a combination of single phase and polyphase depending on the particular application of the relays.

Note that the implementation of the set of relays 105 in FIG. 1 is only illustrative of one embodiment and is not meant to be limiting. Those skilled in the art will recognize that the various embodiments of the present invention are suitable for controlling a varying amount of relay configurations. Generally, the various embodiments of relay control circuit 110 are suitable for use with an electric meter having more than one relay.

For the sake of simplicity in illustrating various embodiments of the present invention, those skilled in the art will recognize that not all features and functionalities associated with electric meter 100 are illustrated in FIG. 1. For example, those skilled in the art will appreciate that electric meter 100 can have specialized microprocessors (e.g., an application processor and a meter processor) that can facilitate the measurement of different electrical services, detection of different conditions, etc. In addition, electric meter 100 may have a liquid crystal display (LCD) or other means to display various parameters. Other components that electric meter 100 may include are memory for storing data and instructions, communication interfaces, a power supply and various other switches.

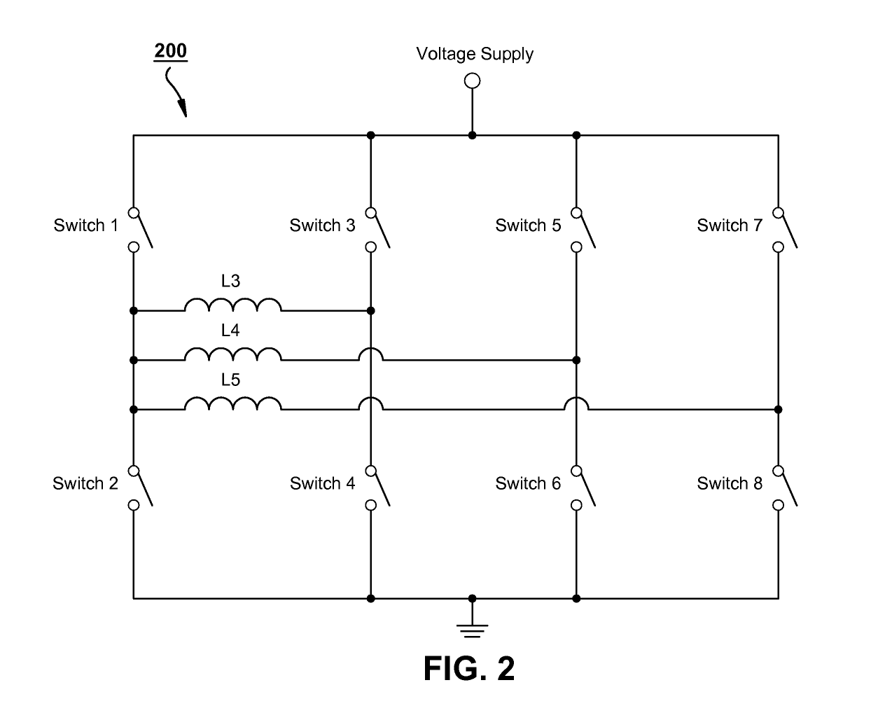

FIG. 2 is a schematic circuit diagram of one embodiment of a relay control circuit 200 that may be implemented in electric meter 100. As shown in FIG. 2, relay control circuit 200 comprises winding relay coils L3, L4 and L5 that connect to a corresponding relay (not shown in FIG. 2). A pair of common control switches (Switch 1 and Switch 2) is connected to relay coils L3, L4 and L5. Control circuit 200 further includes relay coil specific switch pairs coupled to relay coils L3, L4 and L5. In particular, Switch 3 and Switch 4 connect to relay coil L3, Switch 5 and Switch 6 connect to relay coil L4, and Switch 7 and Switch 8 connect to relay coil L5. As shown in FIG. 2, Switch 1, Switch 3, Switch 5 and Switch 7 are connected to a voltage supply, while Switch 2, Switch 4, Switch 6 and Switch 8 are connected to ground.

In operation, common control switches, Switch 1 and Switch 2, operate in conjunction with each pair of the relay coil specific switch pairs (i.e., Switch 3 and Switch 4, Switch 5 and Switch 6, and Switch 7 and Switch 8) to selectively turn on and off relay coils L3, L4 and L5, which control corresponding relays (not shown in FIG. 2). In particular, common control switches, Switch 1 and Switch 2, and Switch 3 and Switch 4 turn on and off relay coil L3, which will control a corresponding relay (not shown in FIG. 2); common control switches, Switch 1 and Switch 2, and Switch 5 and Switch 6 turn on and off relay coil L4, which will control corresponding a relay (not shown in FIG. 2); and common control switches, Switch 1 and Switch 2, and Switch 7 and Switch 8 turn on and off relay coil L5, which will control a corresponding relay (not shown in FIG. 2).

In one embodiment, if one wanted to turn on (i.e. close) relay coil L3, then Switch 1 and Switch 4 would be closed. On the other hand, if one wanted to turn off (i.e. open) relay coil L3, then Switch 2 and Switch 3 would be closed. In another embodiment, if one wanted to turn on relay coil L4, then Switch 1 and Switch 6 would be closed. If one wanted to turn off relay coil L4, then Switch 2 and Switch 5 would be closed. In another embodiment, if one wanted to turn on relay coil L5, then Switch 1 and Switch 8 would be closed. If one wanted to turn off relay coil L5, then Switch 2 and Switch 7 would be closed. Those skilled in the art will recognize that by reversing the relay coil connection the logic can be changed. For example, by connecting the relay coil L3 in reverse direction by controlling Switch 1 and Switch 4 the relay L3 can be turned off. Similarly, relay L3 can be turned ON by controlling Switch 2 and Switch 3.

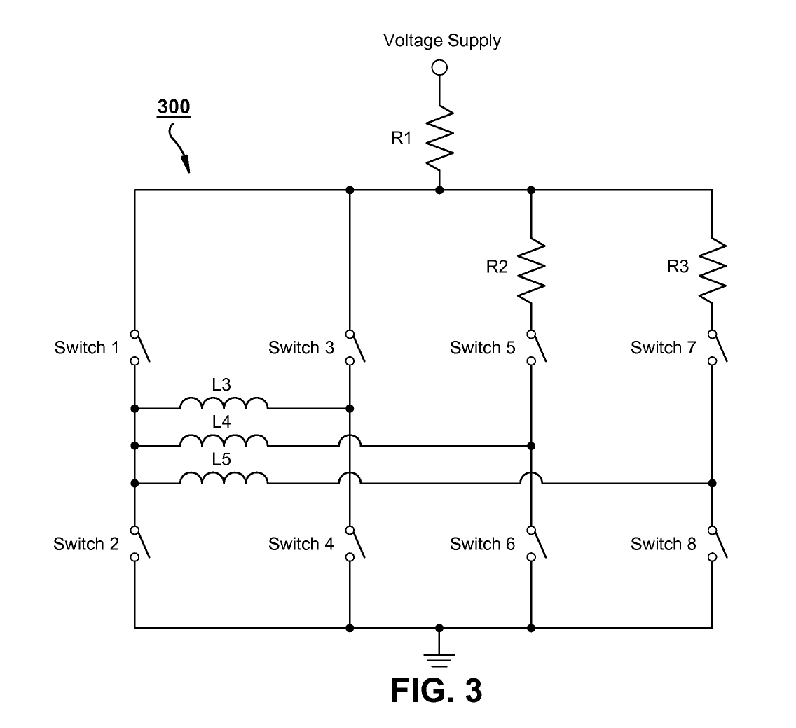

FIG. 3 is a schematic circuit diagram of a relay control circuit 300 that may be implemented in electric meter 100 according to a first alternative embodiment. In this embodiment, a current limit mechanism formed from a network of resistors R1, R2 and R3 is used to avoid shoot through when two switches on the same leg (any one of the pairs of switches (Switch 1 and Switch 2, Switch 3 and Switch 4, Switch 5 and Switch 6, and Switch 7 and Switch 8) are turned on, which can cause permanent damage. For example, if it was desirable to open relay coil L3 (i.e., close Switch 2 and Switch 3) and close relay coil L4 (i.e., close Switch 1 and Switch 6), then Switch 1 and Switch 2 would get shorted. In another example, any external noise may cause Switch 1 and Switch 2 to turn on simultaneously, which could cause permanent damage as well. Another example in which two switches on a leg can short may occur if microcontroller 115 inadvertently causes the switches to close. All of these examples can result in physical damage due to the shorting of the switches.

The current limit mechanism provided by resistors R1, R2 and R3 provides a passive approach to controlling the current through the switch pairs (Switch 1 and Switch 2, Switch 3 and Switch 4, Switch 5 and Switch 6, and Switch 7 and Switch 8). As shown in FIG. 3, resistor R2 is connected to the leg of switch pair formed from Switch 5 and Switch 6, while resistor R3 is connected to the leg of switch pair formed from Switch 7 and Switch 8. In this embodiment, the switch pair formed from Switch 3 and Switch 4 does not have a resistor connected to that leg because the service disconnect relay 120 needs a high current to control as compared to relays 125 and 130. As a result, the current rating of Switches 1, 2, 3, and 4 are higher than the ratings of the other switches (i.e., Switches 5, 6, 7 and 8). Consequently, resistor R1 would be sufficient to protect Switches 1, 2, 3 and 4, while protecting Switches 5, 6, 7 and 8 requires the use of additional resistors (i.e., R2 and R3) added to their legs.

In FIG. 3, resistor R1 is connected between the voltage supply and the node formed from each of the pairs of switches (Switch 1 and Switch 2, Switch 3 and Switch 4, Switch 5 and Switch 6, and Switch 7 and Switch 8). In this embodiment, the function of resistor R1 is to further limit the current flowing through the switches (Switch 1, Switch 2, Switch 3, Switch 4, Switch 5, Switch 6, Switch 7 and Switch 8).

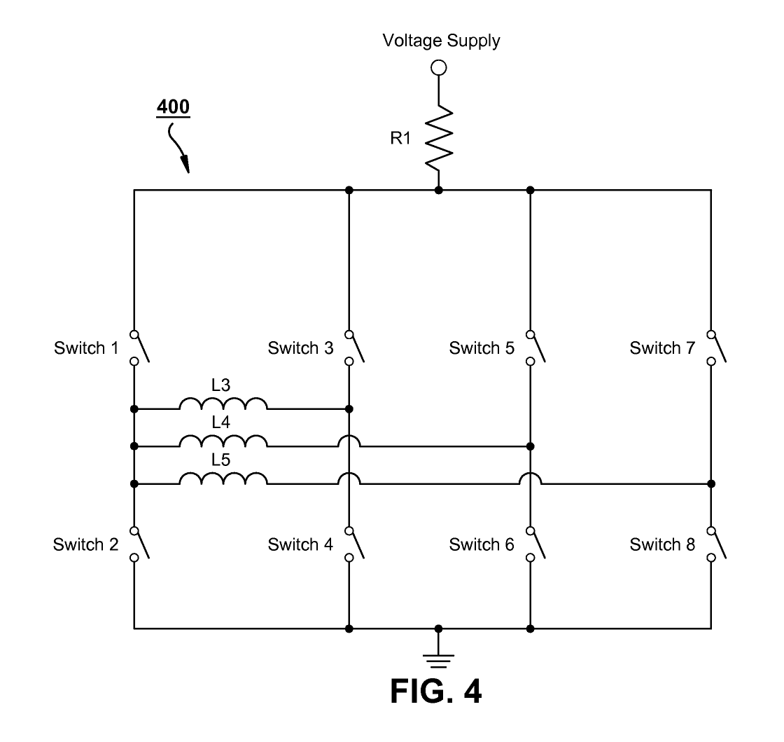

FIG. 4 is a schematic circuit diagram of a relay control circuit 400 that may be implemented in the electric meter depicted in FIG. 1 according to a second alternative embodiment. In this embodiment, a current limit mechanism is formed from resistor R1 to serve the same function as described with respect to FIG. 3. In this embodiment, the current limit mechanism formed from resistor R1 would be suitable for use in scenarios where the relays were all similar current relays, or in scenarios where the rating of the switches (Switch 1, Switch 2, Switch 3, Switch 4, Switch 5, Switch 6, Switch 7 and Switch 8) were all the same.

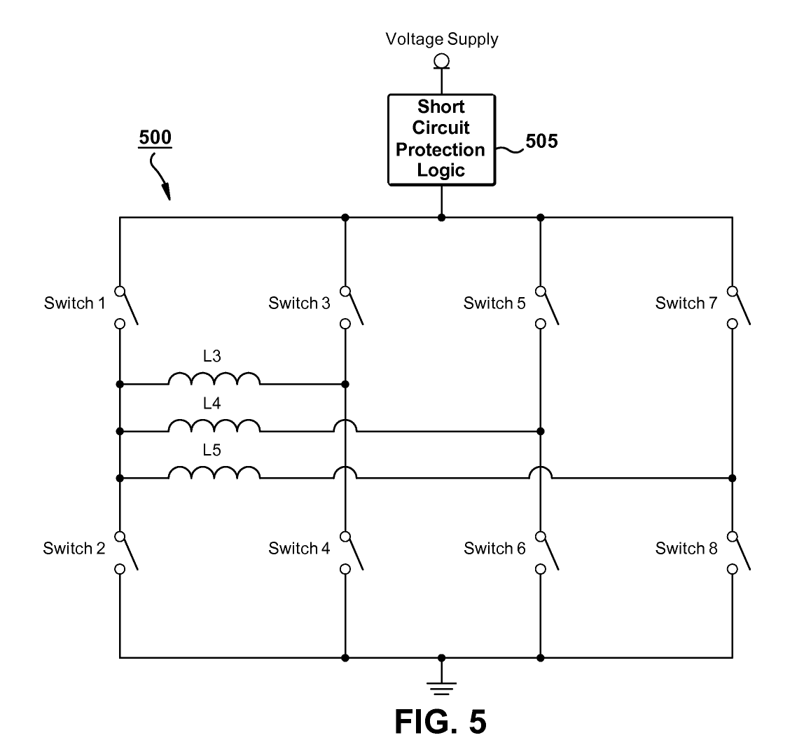

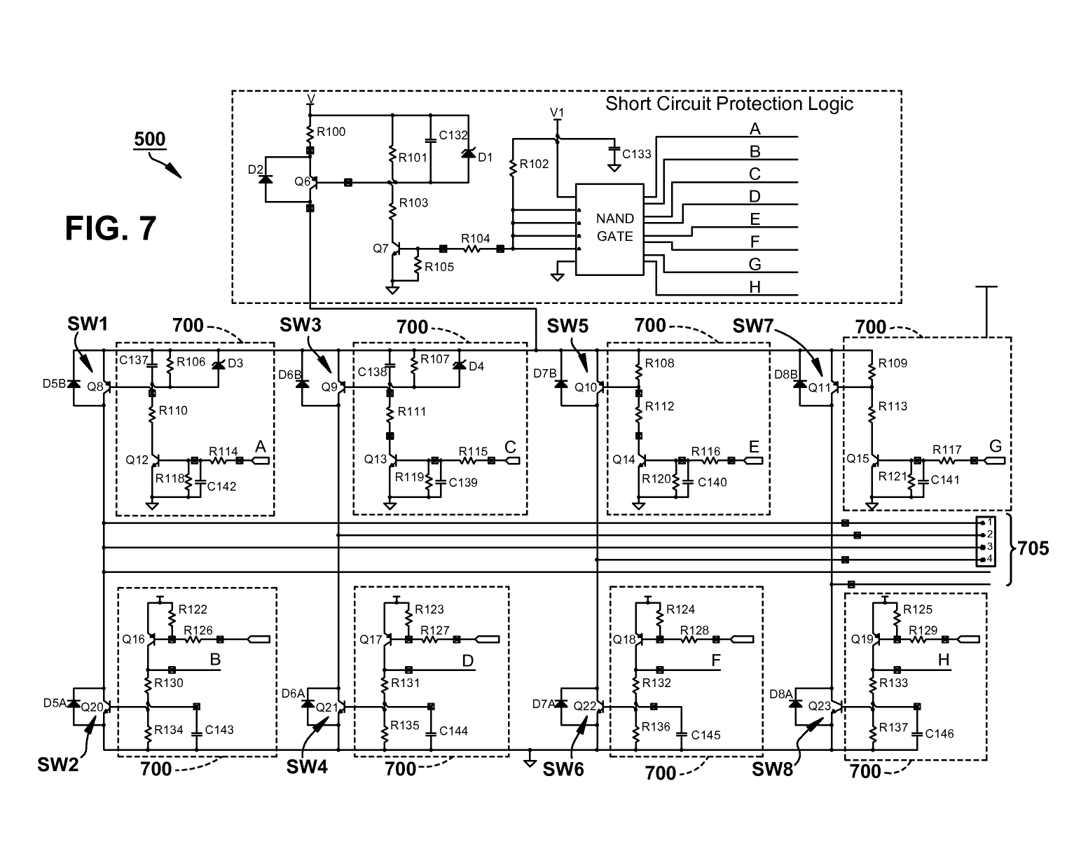

FIG. 5 is schematic circuit diagram of a relay control circuit 500 that may be implemented in electric meter 100 according to a third alternative embodiment. In this embodiment, instead of using a current limit mechanism formed from a resistor network of R1, R2 and R3, or solely resistor R1, the current limit mechanism is formed from short circuit protection logic 505, which provides an active approach to limiting the current going to the switches (Switch 1, Switch 2, Switch 3, Switch 4, Switch 5, Switch 6, Switch 7 and Switch 8). As shown in FIG. 5, short circuit protection logic 505 is coupled to relay control circuit 500. In one embodiment, short circuit protection logic 505 may include the use of a logic gate such as a NAND gate, resistors, and capacitors to introduce a delay in controlling the switches. In operation, the resistors and capacitors introduce a delay that is used to control Switches 1, 2, 3, 4, 5, 6, 7, and 8 between the signal generated from microcontroller 115 (FIG. 1) to the switches. Consequently, if any unintentional operation of Switch 1 and Switch 2 happens simultaneously, then before turning on these switches, short circuit protection logic 505 will turn off an internal switch (e.g., Q6 of FIG. 7) which will protect Switches 1, 2, 3, 4, 5, 6, 7, and 8 from permanent damage.

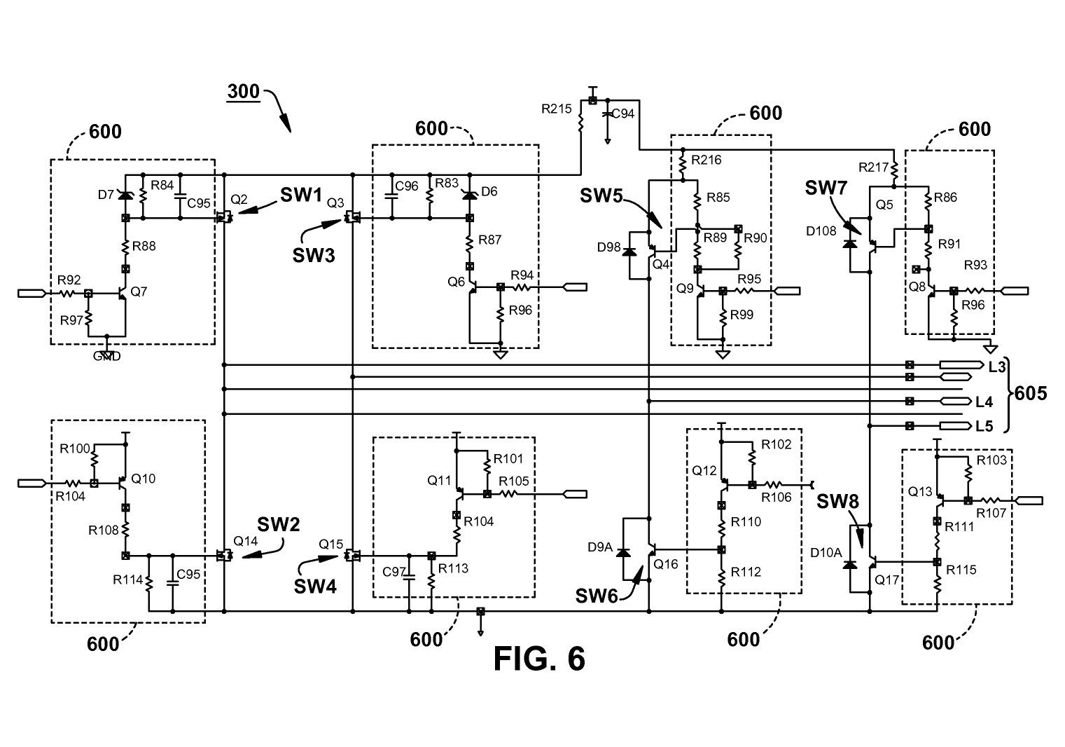

FIG. 6 is a circuit implementation of relay control circuit 300 according to one embodiment of the present invention. In this embodiment, each of the switches (Switch 1, Switch 2, Switch 3, Switch 4, Switch 5, Switch 6, Switch 7 and Switch 8) is implemented by using metal-oxide-semiconductor field-effect transistors (MOSFETs) and Bipolar Junction Transistors (BJTs). As shown in FIG. 6, MOSFET Q2, MOSFET Q14, MOSFET Q3, MOSFET Q15, BJT Q4, BJT Q16, BJT Q5, and BJT Q17, correspond to Switch 1, Switch 2, Switch 3, Switch 4, Switch 5, Switch 6, Switch 7 and Switch 8, respectively. In addition, each of the switches (Switch 1, Switch 2, Switch 3, Switch 4, Switch 5, Switch 6, Switch 7 and Switch 8) has a switch control 600 that controls the opening and closing of their respective switches. As an example, if one desired to close Switch 8, then its respective switch control 600 would turn on BJT Q17 in response to having the voltage supply (e.g., 3.3 volts) turn it on after BJT Q13 received a low input. On the other hand, if one desired to open Switch 8, then its respective switch control 600 would turn off BJT Q17 by not having the voltage supply (e.g., 3.3 volts) (and BJT Q13 receiving a high input). The operation of the other switches (Switch 1, Switch 2, Switch 3, Switch 4, Switch 5, Switch 6, and Switch 7) would work in a similar manner and, thus further explanation is not provided. Depending on how the switches are controlled, their outputs are sent to relay coils L3, L4 and L5 via connection lines 605.

FIG. 7 is a circuit implementation of relay control circuit 500 according to one embodiment of the present invention. In FIG. 7, each of the switches (Switch 1, Switch 2, Switch 3, Switch 4, Switch 5, Switch 6, Switch 7 and Switch 8) is implemented by using BJTs. As shown in FIG. 7, BJT Q8, BJT Q20, BJT Q9, BJTQ21, BJT Q10, BJT Q22, BJT Q11, and BJT Q23, correspond to Switch 1, Switch 2, Switch 3, Switch 4, Switch 5, Switch 6, Switch 7 and Switch 8, respectively. In addition, each of the switches (Switch 1, Switch 2, Switch 3, Switch 4, Switch 5, Switch 6, Switch 7 and Switch 8) has a switch control 700 that controls the opening and closing of their respective switches for operation of relay coils L3, L4 and L5 via connection lines 705. In this embodiment, a current limit mechanism that includes short circuit protection logic 505 is coupled to relay control circuit 500. For sake of simplicity in illustrating the concept of this embodiment, the connection of short circuit protection logic 505 to relay control circuit 500 is not shown, however this is within the knowledge of skilled artisans.

In operation, the resistors and capacitors introduce a delay that is used to control Switches 1, 2, 3, 4, 5, 6, 7, and 8 between the signal generated from microcontroller 115 (FIG. 1) to the switches. Consequently, if any unintentional operation of Switch 1 and Switch 2 happens simultaneously, then before turning on these switches, short circuit protection logic 505 will turn off an internal switch Q6 which will protect Switches 1, 2, 3, 4, 5, 6, 7, and 8 from permanent damage. The operation of the other switches (Switch 1, Switch 2, Switch 3, Switch 4, Switch 5, Switch 6, and Switch 7) in conjunction with short circuit protection logic 505 would work in a similar manner and thus further explanation is not provided.

While the disclosure has been particularly shown and described in conjunction with a preferred embodiment thereof, it will be appreciated that variations and modifications will occur to those skilled in the art. Therefore, it is to be understood that the appended claims are intended to cover all such modifications and changes as fall within the true spirit of the disclosure.

What is claimed is:

1. A circuit, comprising:
a voltage supply;
more than one relay coil each connected to a corresponding relay;
a pair of common control switches connected to each of the relay coils, wherein one of the common control switches is connected to the voltage supply and another of the common control switches is connected to ground or a return line from the voltage supply;
a plurality of relay coil specific switch pairs, each relay coil specific switch pair connected to one of the relay coils, wherein each relay coil specific switch pair is connected to one of the relay coils at an end opposite a connection of the pair of common control switches with each of the relay coils, and wherein each relay coil specific switch pair has a switch that is connected to the voltage supply and another switch connected to ground or the return line from the voltage supply, and wherein the pair of common control switches and the plurality of relay coil specific switch pairs operate cooperatively to selectively open and close the relay coils which selectively open and close a corresponding relay; and
a current limiting mechanism connected to the voltage supply, the plurality of relay coil specific switch pairs and the pair of common control switches, wherein the current limiting mechanism comprises short circuit protection logic that protects the plurality of relay coil specific switch pairs and the pair of common control switches from a short circuit arising in a leg formed from any of the relay coil specific switch pairs and in a leg formed from the pair of common control switches.

2. The circuit according to claim 1, wherein the more than one relay coil comprises three relay coils.

3. The circuit according to claim 2, wherein one of the three relay coils comprises one of a single-phase service disconnect relay coil, a three-phase service disconnect relay coil, a first single-phase load control relay coil, and a second single-phase load control relay coil.

4. The circuit according to claim 1, wherein the short circuit protection logic protects the plurality of relay coil specific switch pairs and the pair of common control switches from a short circuit arising in a leg formed from any of the relay coil specific switch pairs and in a leg formed from the pair of common control switches as a function of a plurality of control signals provided thereto.

5. The circuit according to claim 4, wherein each switch from the plurality of relay coil specific switch pairs and each switch from the pair of common control switches receives one of the plurality of control signals, wherein each switch receives a different control signal.

6. The circuit according to claim 4, wherein the short protection logic comprises a NAND gate that receives the plurality of control signals.

7. The circuit according to claim 4, wherein the short protection logic comprises an internal switch connected to the plurality of relay coil specific switch pairs and the pair of common control switches, wherein the internal switch is configured to protect the plurality of relay coil specific switch pairs and the pair of common control switches from damage in response to being turned off, the internal switch turned on and off as a function of the plurality of control signals.

8. A circuit, comprising:
a voltage supply;
more than one relay coil each connected to a corresponding relay;
a pair of common control switches connected to each of the relay coils, wherein the pair of common control switches connect to each of the relay coils at a common end, and wherein one of the common control switches is connected to the voltage supply and another of the common control switches is connected to ground or a return line from the voltage supply;
a plurality of relay coil specific switch pairs, each relay coil specific switch pair connected to one of the relay coils, wherein each relay coil specific switch pair is connected to one of the relay coils at an end opposite a connection of the pair of common control switches with each of the relay coils, and wherein each relay coil specific switch pair has a switch that is connected to the voltage supply and another switch connected to ground or the return line from the voltage supply; and
a current limiting mechanism connected to the voltage supply, the plurality of relay coil specific switch pairs and the pair of common control switches, wherein the current limiting mechanism comprises short circuit protection logic that protects the plurality of relay coil specific switch pairs and the pair of common control switches from a short circuit arising in a leg formed from any of the relay coil specific switch pairs and in a leg formed from the pair of common control switches.

9. The circuit according to claim 8, wherein the pair of common control switches and the plurality of relay coil specific switch pairs operate cooperatively to selectively open and close the relay coils which selectively open and close a corresponding relay.

10. The circuit according to claim 8, wherein the more than one relay coil comprises one of a single-phase service disconnect relay coil, a three-phase service disconnect relay coil, a first single-phase load control relay coil, and a second single-phase load control relay coil.

11. The circuit according to claim 8, wherein the short circuit protection logic protects the plurality of relay coil specific switch pairs and the pair of common control switches from a short circuit arising in a leg formed from any of the relay coil specific switch pairs and in a leg formed from the pair of common control switches as a function of a plurality of control signals provided thereto.

12. The circuit according to claim 11, wherein each switch from the plurality of relay coil specific switch pairs and each switch from the pair of common control switches receives one of the plurality of control signals, wherein each switch receives a different control signal.

13. The circuit according to claim 11, wherein the short protection logic comprises a NAND gate that receives the plurality of control signals.

14. The circuit according to claim 11, wherein the short protection logic comprises an internal switch connected to the plurality of relay coil specific switch pairs and the pair of common control switches, wherein the internal switch is configured to protect the plurality of relay coil specific switch pairs and the pair of common control switches from damage in response to being turned off, the internal switch turned on and off as a function of the plurality of control signals

15. A utility meter, comprising:
more than one relay;
a relay control circuit configured to selectively open and close each of the relays, the relay control circuit comprising a voltage supply; more than one relay coil each connected to a corresponding relay, a pair of common control switches connected to each of the relay coils, wherein the pair of common control switches connects to each of the relay coils at a common end, and wherein one of the common control switches is connected to the voltage supply and another of the common control switches is connected to ground or a return line from the voltage supply; and a plurality of relay coil specific switch pairs, each relay coil specific switch pair connected to one of the relay coils, wherein each relay coil specific switch pair is connected to one of the relay coils at an end opposite a connection of the pair of common control switches with each of the relay coils, and wherein each relay coil specific switch pair has a switch that is connected to the voltage supply and another switch connected to ground or the return line from the voltage supply, and a current limiting mechanism connected to the voltage supply, the plurality of relay coil specific switch pairs and the pair of common control switches, wherein the current limiting mechanism comprises short circuit protection logic that protects the plurality of relay coil specific switch pairs and the pair of common control switches from a short circuit arising in a leg formed from any of the relay coil specific switch pairs and in a leg formed from the pair of common control switches; and
a microcontroller, operatively coupled to the relay control circuit, that is configured to direct the relay control circuit to selectively open and close the relays.

16. The utility meter according to claim 15, wherein the short circuit protection logic protects the plurality of relay coil specific switch pairs and the pair of common control switches from a short circuit arising in a leg formed from any of the relay coil specific switch pairs and in a leg formed from the pair of common control switches as a function of a plurality of control signals received from the microcontroller.

17. The utility meter according to claim 16, wherein each switch from the plurality of relay coil specific switch pairs and each switch from the pair of common control switches receives one of the plurality of control signals, wherein each switch receives a different control signal.

18. The utility meter according to claim 16 wherein the short protection logic comprises a NAND gate that receives the plurality of control signals.

19. The utility meter according to claim 16, wherein the short protection logic comprises an internal switch connected to the plurality of relay coil specific switch pairs and the pair of common control switches, wherein the internal switch is configured to protect the plurality of relay coil specific switch pairs and the pair of common control switches from damage in response to being turned off, the internal switch turned on and off as a function of the plurality of control signals

20. The utility meter according to claim 15, wherein the utility meter comprises an electric meter.
